(19) United States
(12) Patent Application Publication
(10) Pub. No.: US 2004/0181995 A1
(43) Pub. Date: Sep. 23, 2004

(54) Collapsible crab trap

(76) Inventor: Gerald J. Cheramie, Galliano, LA (US)

Correspondence Address: ROLAND R. SHEA, c/o NORDMAN, CORMANY,, HAIR & COMPTON, P.O. BOX 9100, OXNARD, CA, 93031-9100, US

(21) Appl. No.: 10/391,088

(22) Filed: Mar. 18, 2003

(51) Int. Cl. A01K 69/10

(52) U.S. Cl. 43/105

(57) ABSTRACT

An improved crustacean trap comprises a collapsible frame including two outward folding hinged sides facing each other, and two inward folding hinged sides facing each other. To maintain the trap in an extended position, a tension lanyard is strung between the two outward folding sides. When the tension lanyard is released, the trap collapses into a reduced volume for storage or transportation. Resistive braces coupled to the hinges of the two outward folding sides prevent the tension lanyard from bending or deforming the wire mesh of the trap. The tension lanyard is advantageously comprised of a biodegradable material configured to decompose when lost or abandon in an aqueous environment, but can be comprised of non-biodegradable material. A shoot provides crustaceans access into the trap. The shoot is deformable, and is easily restored to a functional shape when the trap is collapsed and restored to an extended position. An escape hole allows undersized crustaceans a means of escaping from the trap. A bait box for holding bait is disposed within the interior of the trap.

### FIELD OF THE INVENTION

The present invention relates to the field of commercial crustacean traps used to trap live crustaceans. More particularly, the present invention relates to crustacean traps configured to fold into a reduced space when not in use, and to re-expand for use in trapping.

### BACKGROUND OF THE INVENTION

Crab, lobster and other crustaceans are consumed by tens of millions of Americans every year. Most of these crustaceans are provided by commercial fisherman. Crustaceans are normally harvested by trapping. Crab, lobster, and other crustacean traps (crab traps) are typically comprised of a mesh or slatted structure made from a variety of substances. Bait can be placed within the trap to coax the crustacean to enter the trap. Ideally, the mesh or slats are narrow enough and the space between them large enough that the crustacean can see or smell the food in the trap, creating the illusion that the food is largely accessible apart from some minor impediment on the sea floor. The crustacean enters the trap through a funnel-shaped shoot coupled to the top or side of the trap. The shoot exit empties into the inside of the trap. The shoot entrance is often constructed in a funnel-shaped construction having a wide shoot entrance and a narrow shoot exit such. Because crustaceans typically have gangly legs and claws, a funnel shape makes entrance into the trap easy, but exit nearly impossible once the creature has dropped from the shoot exit into the trap. It is almost impossible to re-enter the shoot exit and escape. Wire nubs at the exit of the shoot can further impede re-entry into the shoot once the crab has entered the trap. Additionally, the shoot exit can be positioned several inches off the floor of the trap such that the creature drops into the trap, making it difficult the creature to reach the end of the shoot again even if it wanted to. The smaller and lighter a trap, the more traps a commercial fisherman is able to store in a confined space and transport in a vehicle such as a pick-up truck or flat bed trailer. Therefore, the size and weight of traps represents one of the key limiting factors on the number of traps a commercial fisherman can store and transport. Because the profits of commercial fisherman are largely dependent on the number of traps they can set and maintain, the size and weight of traps therefore represents one of the primary limitations to their commercial success. What is needed therefore is an improved crab trap requiring less space for storage and transportation.

### SUMMARY OF THE INVENTION

The present invention is an improved crustacean trap requiring less size for storage and transportation. According to one embodiment of the invention, an improved crustacean trap for trapping crustaceans comprises a top, a bottom, a collapsible frame coupled to the top and to the bottom, and an entrance shoot coupled to a surface of the trap to enable a crustacean to enter the trap. The collapsible frame is configured to transition between an extended position and a collapsed position. The collapsible frame comprises a plurality of folding sides, including a first and second folding side, each folding side respectively comprising an upper panel and a lower panel pivotably coupled by a hinge means. A force member, in a first configuration, is releasably coupled to the trap in an orientation that exerts a force sufficient to maintain the trap in an extended position. According to one embodiment, the force member is a tension lanyard coupled with the first folding side and with the second folding side, thereby preventing the first and second folding sides from folding to into a collapsed position. The first folding side and the second folding side are configured to fold outward as the trap is transitioned from an extended position to a collapsed position. The tension lanyard is advantageously comprised of a biodegradable material configured to degrade when left in an aqueous environment. A rigid brace is coupled to the first folding side, such that a force from the tension lanyard to the first folding side is transmitted through the rigid brace. The collapsible frame further comprises a first inward folding side and a second inward folding side, wherein the entrance shoot is coupled to the first inward folding side. A stop is coupled to the first rigid brace. The stop is configured to oppose an advancement of an inward folding side. The entrance shoot is preferably formed from a collapsible mesh material so that it can be readily restored to a useful shape if it experiences deformation. A bait box is disposed within an interior of the trap. An escape hole formed in a surface of the trap in order to allow undersized crustaceans to escape from the trap. A trap opening with a door allows crustaceans to be retrieved from the trap.

A method of securing a collapsible crustacean trap into an extended position comprises the steps of securing a tension lanyard to a first folding side; securing the tension lanyard to a second folding side; tightening the tension lanyard; and securing an end of the tension lanyard to a member of the crustacean trap.

A method of collapsing a collapsible crustacean trap having a tension lanyard extending from a first folding side to a second folding side comprises the step of releasing tension in the tension lanyard.

A collapsible crustacean trap configured to collapse into a reduced space comprises a top surface, a bottom surface, a first folding side swivelably coupled to the top surface and to the bottom surface, a second folding side swivelably coupled to the top surface and to the bottom surface, and a tension lanyard configured to couple with the first folding side and with the second folding hinged side. A first inward folding side is also coupled to the top surface and to the bottom surface, and a second inward folding side coupled to the top surface and to the bottom surface.

### BRIEF DESCRIPTION OF THE DRAWINGS

FIG. 1 illustrates an isometric three-dimensional view of a collapsible crab trap according to the present invention.

FIG. 2 illustrates an exploded view of the collapsible crab trap of FIG. 1.

FIG. 3A illustrates two panels at right angles swivelably coupled by wire loops to form a folding side.

FIG. 3B illustrates two panels on a common plane swivelably coupled by wire loops to form a folding side.

FIG. 4 illustrates the top of the trap with an entrance door in a closed position.

FIG. 5 illustrates the top of the trap with the entrance door in the open position.

FIG. 6 a side view of the trap with the inward bending sides slightly bent, and the entrance shoots extending into the trap.

FIG. 7 illustrates the trap of FIG. 6 in a partially collapsed state as inward bending sides bend inward.

FIG. 8 illustrates a side view of a collapsible crab trap including a tension lanyard holding the crab trap in an extended position.

FIG. 9 illustrates the collapsible crap trap of FIG. 8 wherein the tension lanyard has been loosened and the trap is collapsing.

FIG. 10 illustrates in inward folding side that is taller than an adjacent outward folding side, thereby preventing the inward folding side from fully extending.

### DETAILED DESCRIPTION OF THE INVENTION

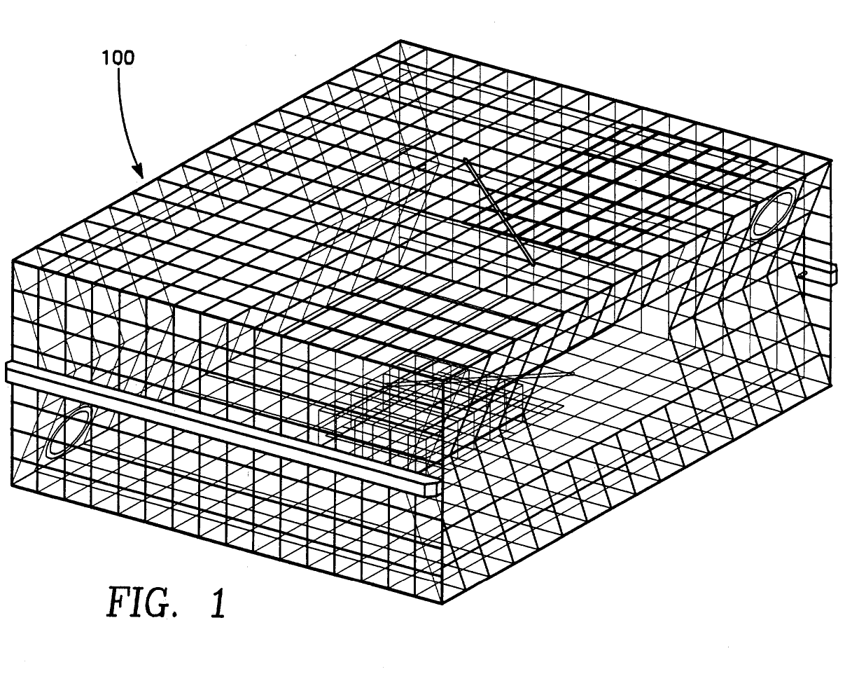

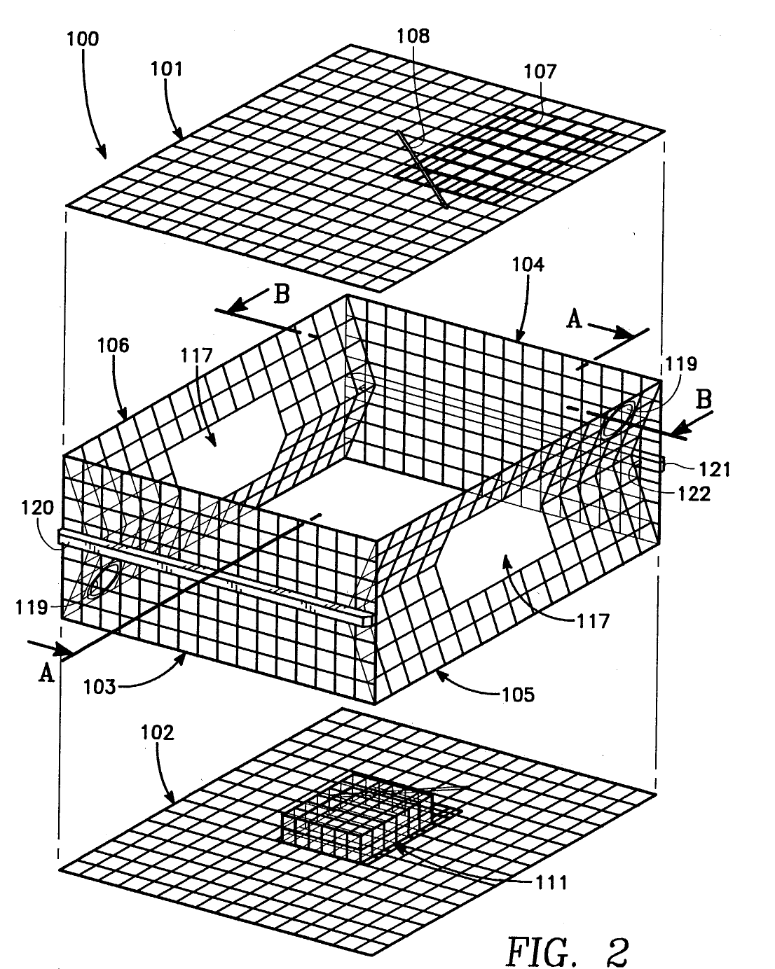

FIG. 1 illustrates a collapsible crap trap 100 of the present invention, the individual components of which are more easily distinguished in the subsequent drawings. FIG. 2 illustrates a blow-up view of a collapsible crab trap 100 of FIG. 1. Although the present invention can be applied to non-cubic shapes, the preferred embodiment advantageously forms a six-sided figure with planes intersecting at right angles when the folding sides are in an extended (unfolded) position. However, the present invention envisions application with non-cubic shapes as well. The trap 100 comprises a top 101, a bottom 102, two opposing outward folding sides 103, 104 interspersed between two opposing inward folding sides 105, 106. To allow the free folding of the folding sides 103, 104, 105, 106, the edges of the folding sides 103, 104, 105, 106 are swivelably coupled to the top 101 and bottom 102 along the respective upper and lower edges, more clearly illustrated by the wire loops 116 of FIG. 5. Because the inward folding 105, 106 and outward folding 103, 104 sides must fold independently however, the inward folding sides 105, 106 are not coupled to the outward folding sides 103, 104 along a vertical line of meeting.

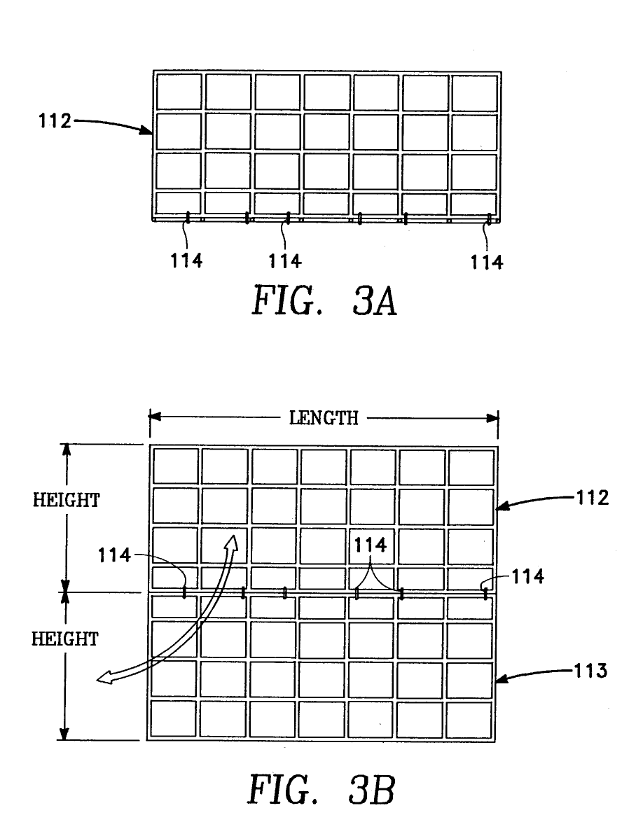

FIGS. 3A and 3B illustrate two panels joined to form a folding side. According to FIG. 3B, an upper panel 112 and a lower panel 113 are joined by a hinge means such as wire loops 114 to form a folding side, such as the folding sides 105, 106 of FIG. 2. FIG. 3A illustrates the same two panels wherein panel 113 is no longer visible, having been swiveled to ninety degrees with respect to panel 112. The reference herein to the height or length of a panel or of a folding side is illustrated by directional arrows in FIG. 3B. The reference to wire loop hinges for coupling adjacent mesh panels and structures throughout this detailed description is not intended to limit the present invention, which envisions the coupling of adjacent panels or mesh structures by any known means, including but not limited to wire loop type hinges.

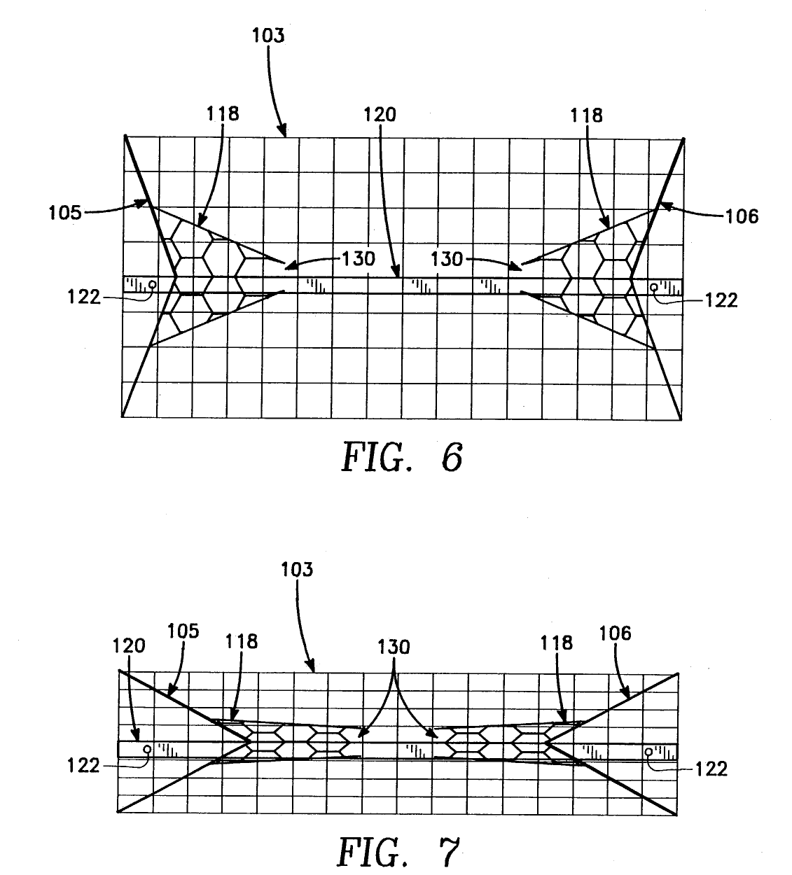

Returning to FIG. 2, depending on the size of the trap and the mesh size, the upper and lower panels 112, 113 are three to four mesh squares “high” as measured from the hinge, and can have any required length. As discussed in greater detail in conjunction with FIGS. 6 and 7, the inward folding sides 105, 106 are prevented from folding outward by virtue of the entrance shoots 118 which can not easily turn inside out, but can easily collapse. As a result, the folding walls having entrance shoots can more naturally fold inward than outward. Because walls 105 and 106 can only fold inward, it can be further appreciated that the “V” of FIG. 2 formed by the junction of the upper and lower panel of the inward folding side 105 along a plane of the respective outward folding side 103 blocks the outward folding side 103 from folding inward. Because the shoots 118 (FIG. 6) prevent the inward folding from folding outward, and the “V” of the inward folding sides prevents the outward folding sides from folding inward, it can be readily appreciated that the natural operation of the trap 100 requires two opposing inward folding sides 105, 106 and two opposing outward folding sides 103, 104.

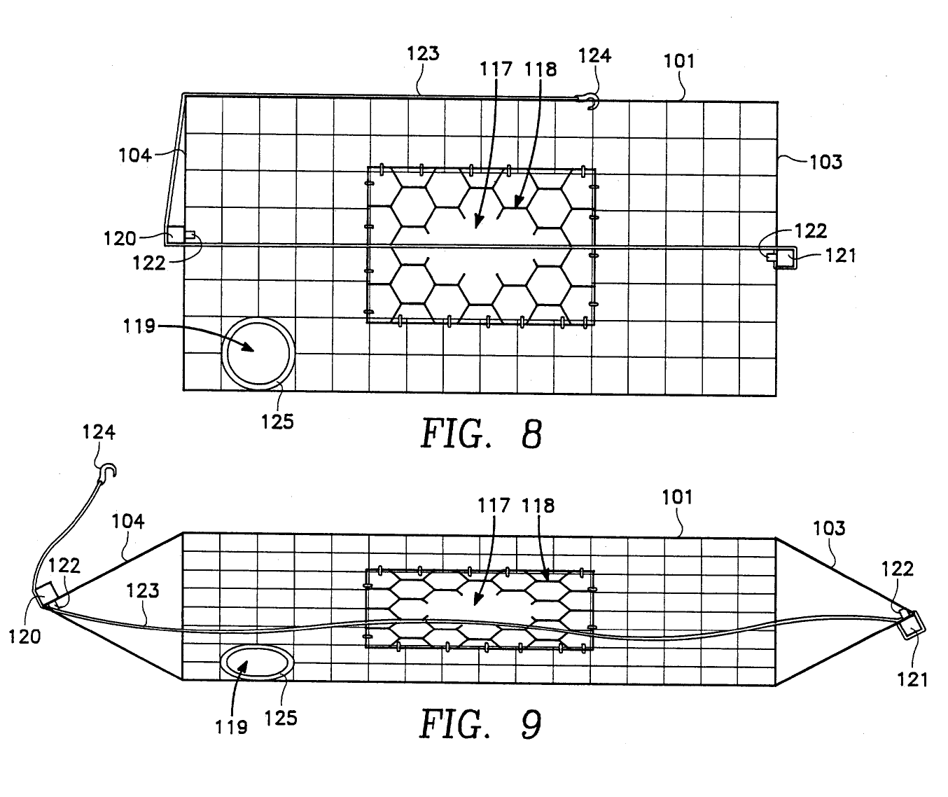

Rigid braces 120, 121 are formed adjacent to the hinges along the outward bending walls 103, 104 to provide structural support against a lanyard pulling inward on these walls, as discussed in conjunction with FIGS. 8 and 9.

The mesh top 101 includes a door 107 hinged at one end and having a door latch such as a tether 108 at the other end. The mesh door 107 grants the fisherman access to the inside of the trap, for example, to retrieve the crabs, lobsters or other crustaceans that have been trapped. The hinge 109 securing one end of the mesh door 107 to the trap is advantageously formed by a plurality wire loops, preferably stainless steel or PVC coated wire. Any known hinge design can be incorporated, however.

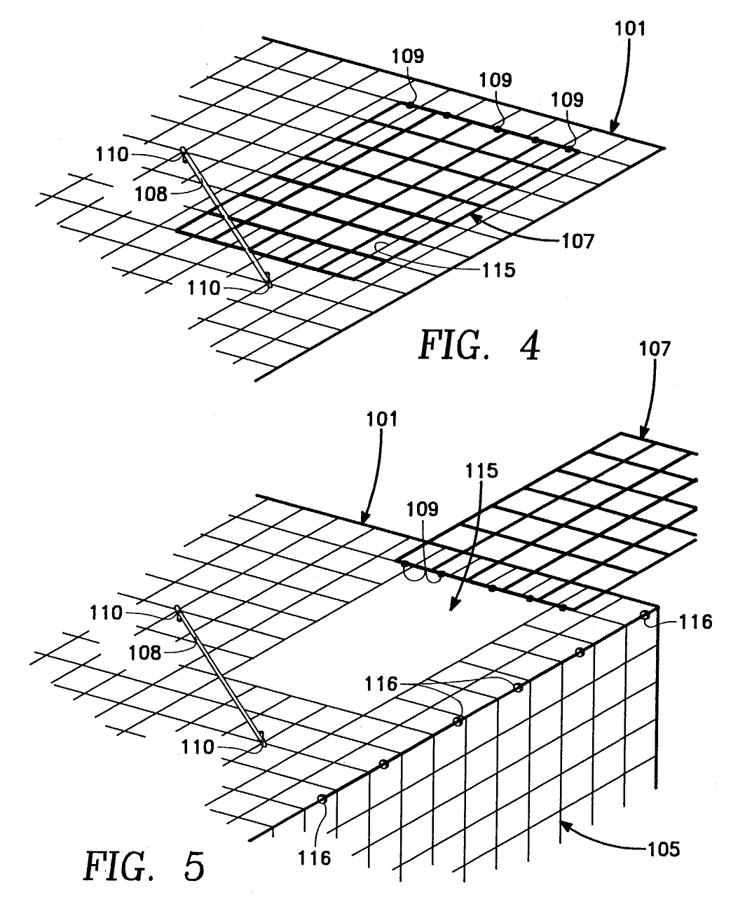

Referring again to FIG. 2, a mesh bait box 111 is placed inside the trap 100, and is preferably coupled to the bottom 102 of the trap 101. To prevent food or bait from drifting out of the bait box with the tides, the mesh used to construct the bait box can be a smaller mesh than the mesh used on the top 101, bottom 102 and sides 103, 104, 105, 106 of the trap. Access to the bait box can be achieved in a variety of designs. According to one embodiment, an opening is cut in the bottom 102of the trap, similar to the door opening 115 (FIG. 5) on the top 101 of the trap. The bait box is formed as a five sided box extending into the trap 100 from the bottom 102. The bait box is secured to the bottom by wire loops. A bait box door is then affixed to the bottom 102 in a manner similar to the door 107 shown in FIGS. 4 and 5. Various bait box constructions are known in the art, and the description herein is not intended to limit the application of the present invention.

Shoot openings 117 (FIG. 2) in the inward folding sides 105, 106 define the place on a folding side where an entrance shoot is coupled to the trap, as further discussed in conjunction with FIGS. 6 & 7. The shoot openings are the entrance point for crustaceans entering the trap 100. Each shoot opening 117 is preferably formed by cutting out mesh both above and below the hinge 114 joining the upper 112 and lower 113 panels (FIG. 3) of an inward folding side 105, 106 (FIG. 2).

The sides 103, 104, 105, 106, top 101 and bottom 102 are formed of corrosion resistant mesh, preferably PVC coated wire mesh which is resistant to the corrosive effects of salt water. The wire gauge used, and the size of the mesh openings, will depend on the application and the particular crustacean being trapped. However, according to one embodiment, the wire mesh will be formed from wire in the range of fourteen gauge to sixteen gauge, with mesh squares of 1½ inch by 1½ inch.

FIGS. 4 and 5 illustrate in greater detail the door 107 to the crab trap 100. The door 107 is swivelably connected to the top 101 by a hinge mechanism such as wire loops 109. A door opening 115 is cut in the wire mesh of the top 101. The door is preferably slightly larger than the opening 115 in the wire mesh top 101. The door 107 is secured in a closed position by a latch mechanism such as a tether 108 stretched across a portion of the door 107. The tether 108 can be detachably coupled to the top 101 by fasteners such as hooks, or, as illustrated in FIGS. 4 and 5, permanently secured by crimping the ends of the tether 108 around a member of the top 101 using wire crimps 110. Those skilled in the art will understand that if the tether 108 is permanently secured, it will advantageously exhibit an elastic quality in order to pull it beyond the door 107 to allow the door to swivel open. The mesh size used to form the door 107 can be the same size, or a different size from the mesh used to form the top 101. Also illustrated in FIG. 5 are wire loops 116 used to connect the top 101 to a side 105.

FIG. 6 illustrates entrance shoots 118 through which crustaceans enter the trap 100. Each shoot 118 is formed from inch-and-a-half hex mesh. The shoots are coupled to the inward bending sides 105 106 at the respective shoot openings 117 and extend into the interior of the trap 100. The shoots 118 are “funnel shaped” such that the cross sectional area of a shoot 118 is greater at the shoot opening 117 and smaller at the shoot exit 130. The funnel shape creates a one-way portal that prevents a crustacean from exiting the trap 100 through the shoot 118 after it has entered the trap. Crustaceans attracted to the bait in the bait box will enter the trap 100 through these shoots 118, thereby trapping them in the trap 100. Because the shoots 118 are formed form hex-mesh, as the collapsible trap 100 is collapsed, the mesh shoots 118 deform, as illustrated in FIG. 7. Because hex-mesh can easily be restored to its original shape, it is very well suited for use as a shoot 118 in the collapsible crab trap 100. The mesh size is exemplary, and is not intended to limit alternative embodiments. The use of hex-mesh is also exemplary, and the present invention envisions a shoot made from any deformable mesh material. Moreover, the present invention envisions alternative embodiments comprising detachable non-deformable shoots.

FIGS. 8 and 9 illustrate a side view of the trap 100 in an extended position (FIG. 8) and partially collapsed position (FIG. 9). Each trap preferably includes at least one escape hole 119 to provide an escape for crustaceans that are under a legal size or weight, or otherwise too small to be commercially viable. The escape hole 119 is not large enough, however, to provide an escape path for crustaceans whose size exceeds the minimum desired size. Cutting the mesh to create an escape hole 137 can leave “nubs” which can catch on the feet and body of an escaping crab, impeding an exit of an undersized crab. This can be avoided by securing a ring 125 (FIGS. 8, 9) within an escape hole 119, thereby covering the nubs and smoothing out the escape hole.

Operation

Because the trap 100 is collapsible for transport and storage, some means must be used to secure it in an expanded position during trapping operations. Moreover, this means must be releasable such that the collapsible trap can be collapsed after trapping operations are completed. FIGS. 8 and 9 show a trap 100 as viewed from perspective A in FIG. 2. According to FIGS. 2, 8 and 9, a stop 122, such as a nail, can be driven part way into the rigid brace. As can be understood from the isometric view of FIG. 2, as the trap is “extended” into an operational state, the inward folding sides 105, 106 move outward. As the extension is performed, the inward folding side moves outward until the mesh material forming the inward folding side engages the stop 122, preventing the inward folding side from over extending.

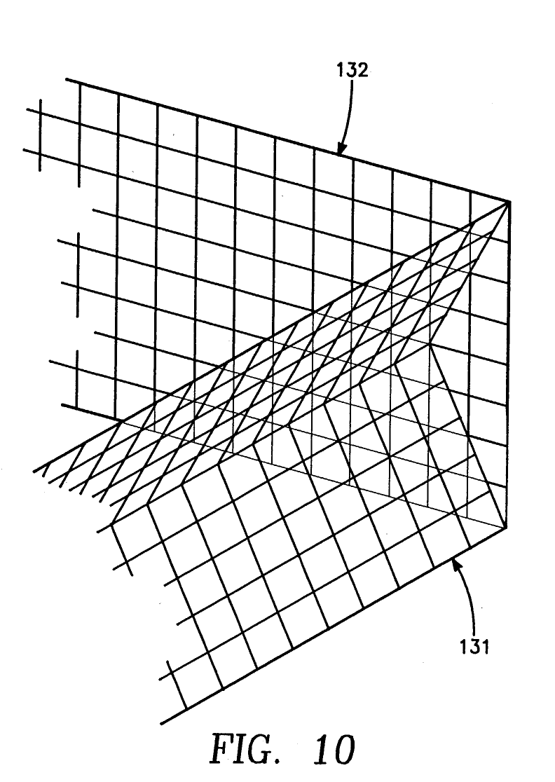

FIG. 10 illustrates an alternative embodiment for restraining an inward folding side from over-extending outward. The inward folding side 131 is comprised of upper and lower panels having a height of five mesh-squares, for a total height of ten mesh-squares. In contrast, the outward folding side 132 comprises panels having a height of four mesh-squares each, for a total height of eight mesh squares. The smaller height of the outward folding side 132 will thus establish the maximum separation distance between the top101 and bottom 102 (not pictured in FIG. 10). As illustrated in FIG. 10, the taller inward folding side 131 cannot fully extend in such a space. As a consequence, it will be impossible for the taller inward folding side 131 to fold outward. As discussed above, once entrance shoots 118 are attached at the shoot openings 117, an inward folding side is endowed with a natural resistance, further preventing it from folding outward. Embodiments such as FIG. 10 enhance this natural resistance.

A tension lanyard 123 exerts the necessary force to maintain the trap 100 in an extended position. A first rigid brace 121 (FIGS. 2, 8 and 9) is attached to outward folding side 104 proximate the line formed along the junction of the upper and lower panels of side 104. A second rigid brace 120 is disposed proximate to the line formed along the junction of the upper and lower panels of outward folding side 103. The tension lanyard 123 is advantageously secured to a first rigid brace 121, extended through the trap 100 and looped around the second rigid brace 120. The tension lanyard 123 is pulled taut and anchored to a point on the trap 100 such as the top 101 by means of a hook 124 or other releasable fastening device, as illustrated in FIGS. 8 and 9. When secured in place, the tension lanyard 123 thereby exerts an inward force on the outward folding sides 103,104, thereby preventing them from collapsing outward. This force maintains the entire crab trap 100 in an “upright” or “extended” position. By looping the lanyard around the rigid brace 121, the force of the lanyard 123 does not act to deform the wire mesh of the trap 100. It can therefore be understood that the rigid braces 120, 121 act as a resistive structure to the tension of the lanyard 123. When the lanyard 123 is released at either end 121, 122, as illustrated in FIG. 9, the trap 100 will collapse to a reduced size.

An alternative embodiment for retaining the trap in an upright position is envisioned, however, wherein a removable locking means locks two abutted sides 103, 105 (FIG. 1) to each other. When the removable locking means are removed, the trap 100 will collapse into a reduced size. The use of tension lanyards 123 or side locking means to maintain a trap in an upright position are exemplary, and are not intended to limit the present invention to these embodiments. Alternatively, removable compression rods between the top 101 and bottom 102 can function to maintain the trap in an extended position during trapping. Although the preferred embodiment envisions the use of a tension lanyard 123, those skilled in the art will recognize that a wide variety of force exerting members can function to maintain the trap 100 in an extended position during trapping exercises.

Occasionally, traps are lost or abandoned. This can cause at least two problems. First, crabs or other crustaceans trapped inside a lost or abandoned trap 100 will eventually consume all the bait and die of starvation. As their bodies decompose, the dead crustaceans will then become bait for other crabs, which will enter the trap and also eventually die. According to this cycle, lost or abandoned traps create a continual influx of live crabs or other crustaceans into the abandoned trap, thereby causing an unnecessary and wasteful cycle of entrapment and death of important members of the bio-sphere. Moreover, traps build according to the present invention can be over two feet tall. When a float marking a trap is lost, the trap can create an unseen hazard to boating, fishing or other aquatic activities. Embodiments are therefore envisioned wherein the tension lanyard 123 is comprised of a material that is bio-degradable in an aqueous environment. As a result, if a trap is lost or abandoned, the lanyard 123 will eventually decompose, allowing the trap to collapse. Once the trap 101 collapses, it exhibits a lower profile, presenting less hazard to boaters and fishermen. Moreover, a collapsed trap prevents the steady influx of crabs or crustaceans into the shoot, thereby avoiding unnecessary trapping and killing of the planet's fragile food supply within oceans and lakes.

The present invention is directed to a collapsible crab trap that can be collapsed to a reduced size for more efficient storage and transportation, the advantages of which will be readily apparent to commercial fishermen. Many features that would be readily understood to one skilled in the art have not been discussed so as to not needlessly obscure important features of the claimed invention. At the same time, the detailed description has included many specific details to enable others to make and use the present invention, but which are not essential to making or using the invention claimed herein in every possible embodiment. Accordingly, these details should not be construed to limit the scope of the claims appended hereto. It will be apparent to those skilled in the art that many modifications can be made to the embodiments described herein without departing from the spirit and scope of the claimed invention.

I claim:

1. An improved crustacean trap for trapping crustaceans comprising a top, a bottom, a collapsible frame coupled to the top and to the bottom, and an entrance shoot coupled to a surface of the trap to enable a crustacean to enter the trap, wherein the collapsible frame is configured to transition between an extended position and a collapsed position.

2. The improved crustacean trap of claim 1 wherein, the collapsible frame comprises a plurality of folding sides, including a first and second folding side, the first and second folding sides respectively comprising an upper panel and a lower panel pivotably coupled by a hinge means.

3. The improved crustacean trap of claim 2 further comprising a force member, wherein, in a first configuration, the force member is releasably coupled to the trap in an orientation that exerts a force sufficient to maintain the trap in an extended position.

4. The improved crustacean trap of claim 3 wherein the force member is a tension lanyard coupled with the first folding side and to the second folding side, thereby preventing the first and second folding sides from folding to into a collapsed position.

5. The improved crustacean trap of claim 4 wherein the first folding side and the second folding side are configured to fold outward as the trap is transitioned from an extended position to a collapsed position.

6. The improved crustacean trap of claim 4 wherein the tension lanyard is comprised of a biodegradable material configured to degrade when left in an aqueous environment.

7. The improved crustacean trap of claim 4 further comprising a rigid brace coupled to the first folding side, wherein a force from the tension lanyard to the first folding side is transmitted through the rigid brace.

8. The improved crustacean trap of claim 7 wherein the collapsible frame further comprises a first inward folding side and a second inward folding side, wherein the entrance shoot is coupled to the first inward folding side

9. The improved crustacean trap of claim 8 further comprising a stop coupled to the first rigid brace, wherein the stop is configured to oppose an advancement of an inward folding side.

10. The improved crustacean trap of claim 1 wherein the entrance shoot is a collapsible mesh material that it can be readily restored to a useful shape if it experiences deformation.

11. The improved crustacean trap of claim 1 further comprising a bait box disposed within an interior of the trap.

12. The improved crustacean trap of claim 1 further comprising an escape hole formed in a surface of the trap in order to allow undersized crustaceans to escape from the trap.

13. The improved crustacean trap of claim 1 further comprising a trap opening with a door for retrieving crustaceans from the trap.

14. A method of securing a collapsible crustacean trap into an extended position comprising the steps:
a. securing a tension lanyard to a first folding side; and
b. securing the tension lanyard to a second folding side.

15. The method according to claim 14 further comprising the steps:
a. tightening the tension lanyard; and
b. securing an end of the tension lanyard to a member of the crustacean trap.

16. A method of collapsing a collapsible crustacean trap having a tension lanyard extending from a first folding side to a second folding side, the method comprising the step of releasing tension in the tension lanyard.

17. A collapsible crustacean trap configured to collapse into a reduced space comprising a top surface, a bottom surface, a first folding side swivelably coupled to the top surface and to the bottom surface, a second folding side swivelably coupled to the top surface and to the bottom surface, and a tension lanyard configured to couple with the first folding side and with the second folding hinged side.

18. The collapsible crustacean trap according to claim 17 further comprising a first inward folding side coupled to the top surface and to the bottom surface, and a second inward folding side coupled to the top surface and to the bottom surface.
